(19) United States
(12) Patent Application Publication
(10) Pub. No.: US 2023/0342327 A1
(43) Pub. Date: Oct. 26, 2023

(54) SYSTEM ON CHIP ARCHITECTURE, INTERPOSER, FPGA AND METHOD OF DESIGN

(71) Applicant: MENTA, Sophia Antipolis (FR)

(72) Inventors: Vincent MARKUS, Longages (FR); Yoan DUPRET, Grasse (FR)

(21) Appl. No.: 17/912,811

(22) PCT Filed: Jan. 6, 2022
(86) PCT No.: PCT/IB2022/050082

§ 371 Date: Sep. 19, 2022

Related U.S. Application Data
(60) Provisional application No. 63/135,156, filed on Jan. 8, 2021.

(51) Int. Cl. G06F 15/78; G06F 30/347

(52) U.S. Cl. CPC G06F 15/7807; G06F 30/347

(57) ABSTRACT

A system on chip device where the active interposer/chassis incorporates an FPGA/eFPGA, which may be used to flexibly implement interposer/chassis operations such as a network on chip communication protocols, state machines, interfaces, or data conversion, digital interfaces operations, data filtering operations, data filtering operations, and the like, or any other digital operation as required, so that analogue and mixed signals only need be addressed in dedicated chiplets.

### FIELD OF THE INVENTION

The present invention relates to System on Chip architectures, and in particular chiplet based architectures.

### BACKGROUND OF THE INVENTION

Modern electronic systems are conventionally structured around a monolithic integrated circuit, that is to say, a complete electronic circuit on a single semiconductor substrate implementing all desired functions, possible in connection with similar such devices and ancillary devices.

FIG. 1 shows a conventionally structured electronic system. As shown in FIG. 1, there is provided a single silicon substrate 100, in a housing 110. Integrated circuitry forming operational block 101, 102, 103, 104 are formed on the substrate by the techniques familiar to the skilled person. These blocks may perform discrete operations (central processor unit, graphical processor unit, memory, custom logic, or any other function as may be required, and are typically interconnected with integrated, hard wired data busses, power supply lines and the like (not shown).

The increasing complexity of many modern devices such as computer processors, signal processors, decoders and so on means that many millions of gates are combined on a single substrate, making a large and complex device, for a single, specific purpose. Recently, an alternative approach has developed according to which modular “chiplets” are defined, each chiplet being an integrated circuit block that has been specifically designed to work with other similar chiplets, defined in terms of IP Blocks, to form larger more complex chips. A System on Chip device may then be developed by combining different chiplets from a standard library to achieve the desired effect.

FIG. 2a shows a chiplet based system on chip device in a first example. As shown in FIG. 2a, there are provided a multiple silicon substrates 201, 202, 203, 104, in a housing 200. Each substrate 201, 202, 203, 204 incorporates Integrated circuitry which may perform discrete operations (central processor unit, graphical processor unit, memory, custom logic, or any other function as may be required and are typically interconnected with integrated, hard wired data busses, power supply lines and the like.

Where a particular System on Chip design is developed on this basis, an additional circuit known as an active interposer is typically provided as a further component of the System On Chip device. The functions of the active interposer may include clock generation, distribution or management for the chiplets, power management, routing of communications between chiplets, and other coordinating functions as may be required.

Accordingly, FIG. 2a further shows active interposer 220a, in communication with chiplets 201, 202, 203, 204, providing these functions as required.

FIG. 2b shows a chiplet based system on chip device in a second example. As shown in FIG. 2b, there are provided multiple chiplets 201, 202, 203, 104, in a housing 210. Each chiplet 201, 202, 203, 204 incorporates Integrated circuitry which may perform discrete operations (central processor unit, graphical processor unit, memory, custom logic, or any other function as may be required and are typically interconnected with integrated, hard wired data busses, power supply lines and the like, in the same way as FIG. 2a.

FIG. 2b meanwhile further shows another possible implementation of an active interposer or chassis 220b in a 3D system, in communication with chiplets 201, 202, 203, 204, providing these functions as required. As shown in FIG. 2b, the active interposer 220b is provided as a separate layer situated below (or above) substrates 201, 202, 203, 204.

It is desirable to provide improved mechanisms for implementing active interposer functionality.

### SUMMARY OF THE INVENTION

In accordance with the present invention in a first aspect there is provided a disaggregated system-on-chip device comprising adapted to perform a specified function, said device comprising a plurality of chiplets from a predefined library of chiplets, each said chiplet implementing one or more specified operation and having a predetermined structure, and an active interposer to provide interoperability functions between said chiplets in view of said specified function, characterized in that said active interposer comprises an FPGA.

In accordance with the present invention in a second aspect there is provided active interposer device for use in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer providing interoperability functions between said chiplets in view of said specified function, characterized in that said active interposer comprises an FPGA.

In accordance with the present invention in a third aspect there is provided an FPGA device for use in an active interposer in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer providing interoperability functions between said chiplets in view of said specified function.

In a development of the first, second or third aspect, the FPGA is configured to perform digital functions of said device other than interoperability functions.

In a development of the first, second or third aspect, the FPGA is configured to perform at least a part of said interoperability functions.

In a development of the first, second or third aspect, the interoperability functions comprise a network on chip.

In a development of the first, second or third aspect, the interoperability functions comprise one or more of communication protocols, state machines, interfaces, or data conversion.

In a development of the first, second or third aspect, the interoperability functions comprise Data conversion operations.

In a development of the first, second or third aspect, the interoperability functions comprise digital interfaces operations.

In a development of the first, second or third aspect, the interoperability functions comprise data filtering operations.

In a development of the first, second or third aspect, the FPGA further comprises Non-Volatile Memory coupled to store programming bitstream of the FPGA.

In accordance with the present invention in a fourth aspect there is provided a method of designing a disaggregated system-on-chip device to perform a specified function said method, comprising the steps of selecting a plurality of chiplets from a predefined library of chiplets, each said chiplet implementing one or more specified operation and having a predetermined structure, defining an active interposer to provide interoperability functions between said chiplets in view of said specified function, wherein said step of defining an active interposer comprises configuring an FPGA to perform at least a part of interoperability functions.

In accordance with the present invention in a fourth aspect there is provided a computer-readable medium comprising instructions which, when executed by a computer, cause the computer to carry out the steps of the preceding method.

In accordance with the present invention in a fifth aspect there is provided data structure defining an FPGA device for use in an active interposer/chassis in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer/chassis providing interoperability functions between said chiplets in view of said specified function.

### BRIEF DESCRIPTION OF THE DRAWINGS

The above and other advantages of the present invention will now be described with reference to the accompanying drawings, in which:

FIG. 1 shows a conventionally structured electronic system;

FIG. 2a shows an example of chiplet based system on chip device in a first example;

FIG. 2b shows a chiplet based system on chip device in a second example;

FIG. 3 shows schematically an example of an FPGA system as known in the state of the art;

FIG. 4 shows further detail of elements of an FPGA system as known in the state of the art;

FIG. 5 shows a disaggregated system-on-chip device in accordance with an embodiment; and

FIG. 6 shows a disaggregated system-on-chip device in accordance with an embodiment.

### DETAILED DESCRIPTION

FPGAs are a type of Programmable Logic Device. They are generally based on a standard programmable logic block, a large number of which are arranged together to implement various functions.

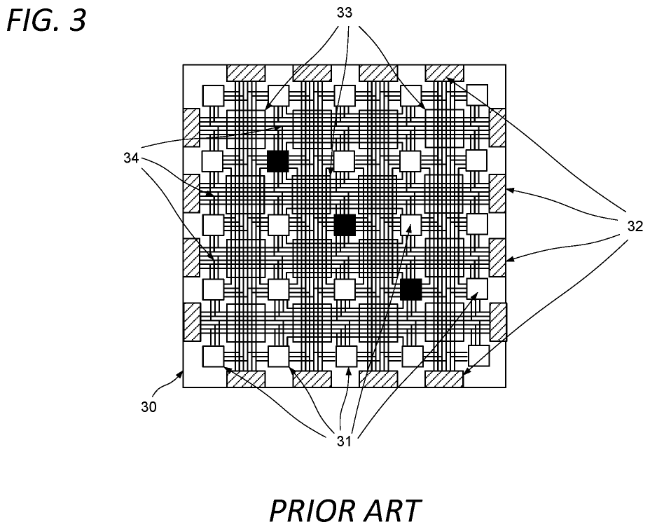

FIG. 3 shows schematically an example of an FPGA system as known in the state of the art.

As shown in FIG. 3, an FPGA chip 30 comprises a number of logic blocks 31, for example as described above. The chip also comprises a number of input/output ports 32. Connecting these logic blocks 31 and input/output ports 32 are a number of tracks 34. At junction points of these tracks are provided and number of programmable routing areas 33, which may also be referred to as switch boxes. In these programmable routing areas there are provided switches which can selectively connect any pair of intersecting tracks, under the control of a logical value stored in a bit cell memory connected with each switch. The bit cell memory values are set at system start up from a non-volatile memory. Accordingly, by setting the values in the switch memories as required, any connections of any logic block can be coupled to those of any other logic block, or any input/output port 32. Similarly any one input/output port may be connected to any other input/output port. Thus, by properly configuring the memory units to define the operation of each logic block, and the switch memories 33 to establish appropriate connections between the logic blocks, any desired functionality can be implemented.

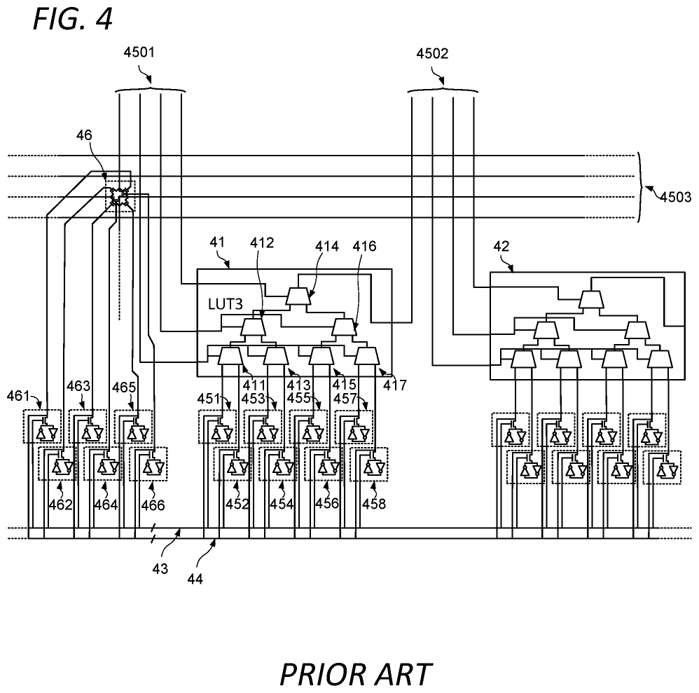

FIG. 4 shows further detail of elements of an FPGA system as known in the state of the art.

The elements shown in FIG. 4 constitute a representative example of a partial implementation of parts of the functionality described above with respect to FIG. 2.

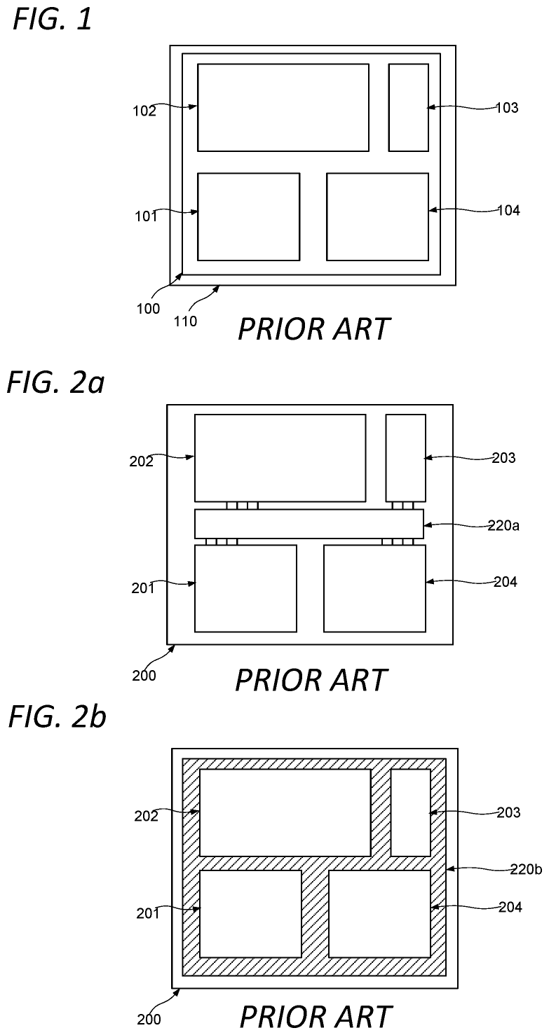

As shown in FIG. 4, there is provided a first Look Up Table (LUT) 41, and a second Look Up Table (LUT) 42, and a number of further LUTs (not shown). Each LUT thus corresponds to a logic block 11 as described in FIG. 1, although in real FPGA implementations each logic block will generally comprise more than one LUT, and possibly other circuits extending or enhancing the functionality of the logic block, such that logic block of different types may be defined with characteristic functionality. The first LUT 41 comprises seven, two input multiplexers 411, 412, 413, 414, 415, 416, 417 respectively. The second LUT and further LUTs are configured similarly. These multiplexers are arranged in a cascading manner with three rows so as to constitute an 8 input multiplexer, the output of which constitutes the output of the LUT. The first row of multiplexers (411, 413, 415 and 417) in each cascade arrangement both have a total of eight inputs. These eight inputs constitute the programming inputs of the first LUT 41. The selection inputs of each row are ganged together, to constitute the three data inputs of the LUT. The data inputs and data output of the first LUT are connected to a set of tracks 4501, 4502. The inputs and outputs of the second and further LUTs are connected correspondingly to a network of further tracks (not shown). Conventionally a LUT with 3 data inputs in this manner is referred to as a “LUT3”. This is generally termed the LUT size, and the number of LUTs of each size required to implement a particular operation is a basic element in designing an FPGA to implement that operation. Each of the eight programming inputs of the first LUT 21 is connected to a respective bit cell memory 451, 452, 453, 454, 455, 456, 457, 458. Corresponding bit cells provide the configuration inputs of the second LUT 22, and the other LUTs provided in the system (not shown). In operation, these bit cell memories 451, 452, 453, 454, 455, 456, 457, 458 provide a constant predetermined logical value to each of the eight programming inputs of each LUT. The content of each bit cell memory is shown schematically as comprising a latch built of two inverters, each receiving the output of the other, with a transistor switch, switched by a respective word line, provided to enable the selective output of the value on the output of one of the inverters in the latch to a bit line connected to a respective configuration input of the LUT 417, and also to a respective data line by means of which the value of the latch may be set. The bit line of each bit cell memory 451, 452, 453, 454, 455, 456, 457, 458 is connected to a selection bus 43, and the word line of each bit cell memory 451, 452, 453, 454, 455, 456, 457, 458 is connected to a data bus 44. During an initiation phase for the circuit, each bit cell memory 451, 452, 453, 454, 455, 456, 457, 458 is addressed in turn, and the desired value set to the latch in question. The logical behaviour of the LUT in response to any binary value on its three data inputs can thus be defined as required. This is the underlying basic concept of FPGA technology. It will be appreciated however that the functions that a single logic block comprising two LUT3s can implement are limited, however by interconnecting a number of suitably configured LUTs as described above, any arbitrary combinatorial function can be implemented. This interconnection is achieved through a programmable interconnection of the data channels 4501, 4502, and further channels (not shown) carrying data from other LUTs. As shown whilst channels 4501, 4502 are arranged vertically, there is provided a further channel 4503 intersecting channels 2501, 2502. At the intersection of respective lines of channels 4501 and 4503 is provided a programmable switching unit 46. Considering that the intersection of the two lines constitutes a total of four connections at the switching unit, the switching unit comprises 6 transistor switches, arranged to make or break a connection between any two of these four connections. Each of these transistor switches is set to be open or closed by a value received from a respective bit cell memory 461, 462, 463, 464, 465, 466. Further such programmable switching units, with corresponding bit cell memories are provided at many or all track intersections (not shown). These bit cell memories 461, 462, 463, 464, 465, 466 as shown are identical to the bit cell memories 451, 452, 453, 454, 455, 456, 457, 458, and connected to the same selection bus 43 and data bus 44, so that during an initiation phase for the circuit, both the LUT bit cell memories and switch bit cell memories may be addressed in turn, and the desired value set to the latch in question, so that the behaviour of each LUT, and its connections to any other LUT may be configured as required.

WO2012/123243 A1, U.S. Pat. Nos. 7,463,056 B1, 6,021,513 A, 5,432,441 A, 8,091,001 B2, 5,675,589 A, and 5,027,355 A describe certain aspects of the foregoing.

The article entitled “Bridging the Gap between Soft and Hard eFPGA Design”, by Victor Olubunmi Aken'Ova chapter 3.22 available from https://www.ece.ubc.ca/˜lemieux/publications/akenova-masc2005.pdf provides

The skilled person will appreciate that many other FPGA architectures are known, from which aspects may be adopted as required.

Furthermore, it may be noted that the principles described herein apply equally to an eFPGA, or “embedded FPGA”. An eFPGA implements the same operating principles as a discrete FPGA device, but takes the form of a digital definition of the functionality in question, often referred to as an “IP”, which may be incorporated at the design state into a larger device, for example taking the form of a System on Chip or Application Specific Integrated Circuit. As such, embodiments of the present invention may take the form of such a digital definition. As such, there is provided a data structure defining an FPGA device as presented herein.

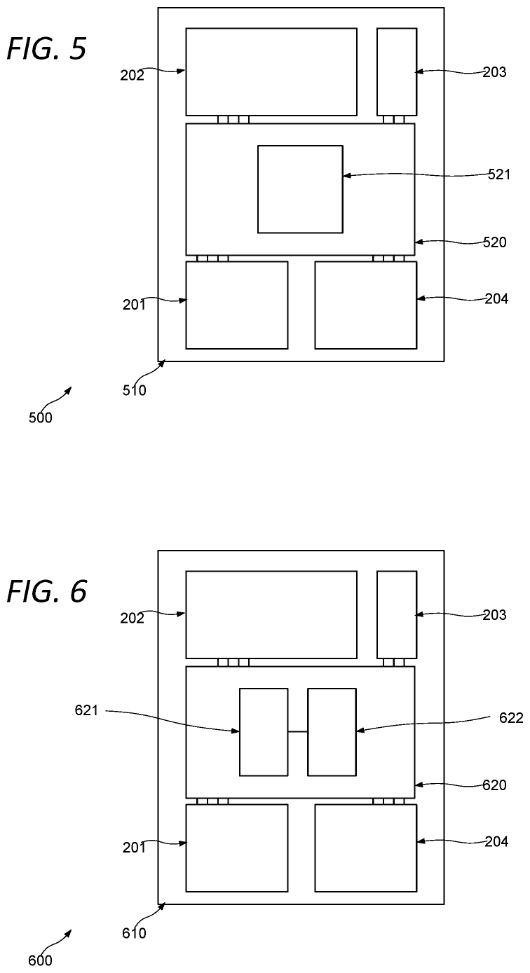

FIG. 5 shows a disaggregated system-on-chip device in accordance with an embodiment.

As shown in FIG. 5, there is provided a disaggregated system-on-chip device 500 comprising a plurality of discrete integrated circuits (chiplets) providing respective functions in a unitary chip carrier package, said device further comprising active interposer 520 performing functions generally as described above, characterized in that the active interposer 520 further integrates FPGA/EFPGA circuits 521 for example as described with reference to FIGS. 3 and 4. It may be noted that an interposer may take any physical configuration, for example as discussed above with respect to element 220a or 220b of FIG. 2a or 2b. In particular, the interposer may be provided in a “chassis” configuration below (or above) the chiplets as discussed with respect to FIG. 2b, and possibly providing physical support thereto, or be provided next to the chiplets, as discussed with respect to FIG. 2a.

As such, there is provided a disaggregated system-on-chip device adapted to perform a specified function, the device comprising a plurality of chiplets from a predefined library of chiplets, each chiplet implementing one or more specified operation and having a predetermined structure, and an active interposer to provide interoperability functions between said chiplets in view of said specified function, characterized in that said active interposer comprises an FPGA/eFPGA.

By incorporating FPGA/eFPGA circuit 521 in active interposer 520, the flexibility of the active interposer is greatly increased—the FPGA/eFPGA functionality may be used to define the active interposer functionality itself, that is to say, providing interoperability functions supporting interoperability of the chiplets, including for example those described in further detail below. For example, the FPGA/eFPGA circuits may be programmed to provide timing or signal translations functions in order to directly support and implement the role of the active interposer in enabling communications between chiplets 201, 202, 203, 204. Still further, logic or other digital operations that might otherwise have been implemented in dedicated chiplets may be implemented directly in the active interposer 520, leaving analogue and mixed signal operations for example to be performed in dedicated chiplets 201, 202, 203, 204.

Accordingly, the active interposer 520 may provide the basis of a reconfigurable network on chip, providing buses for interconnection between chiplets, by suitable configuration of the integrated FPGA/eFPGA 521.

The active interposer 520 may provide a basis for configurable logic, for example to implement communication protocols, state machines, interfaces, data conversion or the like by suitable configuration of the integrated FPGA/eFPGA 521.

The active interposer 520 may provide a basis for configurable logic, for example to implement Data conversion operations by suitable configuration of the integrated FPGA/eFPGA 521.

The active interposer 520 may provide a basis for configurable logic, for example to implement on or off-chip digital interfaces operations by suitable configuration of the integrated FPGA/eFPGA 521.

The active interposer 520 may provide a basis for configurable logic, for example to implement in or off chip data filtering operations by suitable configuration of the integrated FPGA/eFPGA 521.

The skilled person will appreciate that the active interposer may implement any or all of these interoperability functions or other operations in combination, and or other operations, by suitable configuration of the integrated FPGA/eFPGA 521.

As such, there is provided an active interposer device for use in a disaggregated system-on-chip comprising adapted to perform a specified function, the disaggregated system-on-chip comprising a plurality of chiplets from a predefined library of chiplets, each chiplet implementing one or more specified operation and having a predetermined structure, the active interposer providing interoperability functions between the chiplets in view of said specified function, characterized in that said active interposer comprises an FPGA/eFPGA.

As such, there is provided FPGA/eFPGA device for use in an active interposer in a disaggregated system-on-chip comprising adapted to perform a specified function, the disaggregated system-on-chip comprising a plurality of chiplets from a predefined library of chiplets, each chiplet implementing one or more specified operation and having a predetermined structure, said active interposer providing interoperability functions between said chiplets in view of the specified function.

It will be appreciated that an FPGA as described above may constitute part of a larger System on Chip or ASIC, resulting for example from the integration of a digital definition of such an FPGA (“IP”) as described herein being incorporated in the design of such a System on Chip or ASIC.

FIG. 6 shows a disaggregated system-on-chip device in accordance with an embodiment.

As shown in FIG. 6, there is provided a disaggregated system-on-chip device 500 comprising a plurality of discrete integrated circuits providing respective functions in a unitary chip carrier package, said device further comprising active interposer 620 performing functions generally as described above, characterized in that the active interposer 620 further integrates FPGA/eFPGA circuits 621 for example as described with reference to FIGS. 3 and 4. As shown, the system of FIG. 6 further comprises memory 622, such as Non-Volatile Memory which may be coupled to the eFPGA/eFPGA IP within the interposer to store programming bitstream of the FPGA/eFPGA for example as described with reference to FIG. 2 or 3.

Accordingly, there is furthermore provided an FPGA/eFPGA for incorporation in an active interposer, wherein the FPGA/eFPGA is configured to implement any of the operations described above.

Accordingly, there is furthermore provided an active interposer incorporating an FPGA/eFPGA as defined above and configured to implement any of the operations described above.

As described previously, a disaggregated system-on-chip device incorporating an active interpose comprising an FPGA/eFPGA as described above for example with reference to FIG. 4 or 5, an active interposer comprising an FPGA/eFPGA as described above for example with reference to FIG. 4 or 5, or an FPGA/eFPGA as described above for example with reference to FIG. 4 or 5, may be defined as an integrated circuit “IP”, that is to say, as a digital definition of the structures in question in accordance with fabless manufacturing processes.

As such, there is provided a data structure defining a disaggregated system-on-chip device incorporating an active interposer comprising an FPGA/eFPGA as described above for example with reference to FIG. 4 or 5. Similarly, there is provided a data structure defining an active interposer comprising an FPGA/eFPGA as described above for example with reference to FIG. 4 or 5. Still further, there is provided a data structure defining or an FPGA/eFPGA as described above for example with reference to FIG. 4 or 5.

Furthermore, there is provided a computer-readable medium comprising a data structure as described above.

Furthermore, there is provided a computer program comprising instructions which, when the program is executed by a computer, cause the computer to control operations of a semiconductor foundry to form a disaggregated system-on-chip device incorporating an active interpose comprising and FPGA/eFPGA as described above for example with reference to FIG. 4 or 5. Similarly, there is provided a computer program comprising instructions which, when the program is executed by a computer, cause the computer to control operations of a semiconductor foundry to form an active interposer comprising an FPGA/eFPGA as described above for example with reference to FIG. 4 or 5. Still further, there is provided a computer program comprising instructions which, when the program is executed by a computer, cause the computer to control operations of a semiconductor foundry to form an FPGA/eFPGA as described above for example with reference to FIG. 4 or 5.

There is additionally provided a computer-readable medium comprising instructions which, when executed by a computer, cause the computer to control operations of a semiconductor foundry to form a device as discussed in the preceding paragraph.

According to a further embodiment, there is provided a method of designing a disaggregated system-on-chip device to perform a specified function said method, comprising the steps of selecting a plurality of chiplets from a predefined library of chiplets, each said chiplet implementing one or more specified operation and having a predetermined structure, defining an active interposer to provide interoperability functions between said chiplets in view of said specified function, wherein said step of defining an active interposer comprises configuring an FPGA/eFPGA to perform at least a part of interoperability functions. The interoperability functions may include any or all of those discussed above.

There is additionally provided a computer-readable medium comprising instructions which, when executed by a computer, cause the computer to carry out the steps of the preceding method.

Accordingly, there is provided a system on chip device where the active interposer incorporates an FPGA/eFPGA, which may be used to flexibly implement interposer operations such as a network on chip communication protocols, state machines, interfaces, or data conversion, digital interfaces operations, data filtering operations, data filtering operations, and the like, or any other digital operation as required, so that analogue and mixed signals only need be addressed in dedicated chiplets.

The subject matter of the present disclosure includes all novel and non-obvious combinations and sub-combinations of the various processes, systems and configurations, and other features, functions, acts, and/or properties disclosed herein, as well as any and all equivalents thereof.

1. A disaggregated system-on-chip device comprising adapted to perform a specified function, said device comprising a plurality of chiplets from a predefined library of chiplets, each said chiplet implementing one or more specified operation and having a predetermined structure, and an active interposer to provide interoperability functions between said chiplets in view of said specified function, wherein said active interposer comprises an FPGA.

2. An active interposer device for use in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer providing interoperability functions between said chiplets in view of said specified function, wherein said active interposer comprises an FPGA.

3. An FPGA device for use in an active interposer in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer providing interoperability functions between said chiplets in view of said specified function.

4. The device of claim 1, wherein said FPGA is configured to perform digital functions of said device other than interoperability functions.

5. The device of claim 1, wherein said FPGA is configured to perform at least a part of said interoperability functions.

6. The device of claim 1, wherein said interoperability functions comprise a network on chip.

7. The device of claim 5, wherein said interoperability functions comprise one or more of communication protocols, state machines, interfaces, or data conversion.

8. The device of claim 5, wherein said interoperability functions comprise Data conversion operations.

9. The device of claim 5, wherein said interoperability functions comprise digital interfaces operations.

10. The device of claim 5, wherein said interoperability functions comprise data filtering operations.

11. The device of claim 1, wherein said FPGA further comprises Non-Volatile Memory coupled to store programming bitstream of the FPGA.

12. A method of designing a disaggregated system-on-chip device to perform a specified function said method, comprising the steps of selecting a plurality of chiplets from a predefined library of chiplets, each said chiplet implementing one or more specified operation and having a predetermined structure, defining an active interposer to provide interoperability functions between said chiplets in view of said specified function, wherein said step of defining an active interposer comprises configuring an FPGA to perform at least a part of interoperability functions.

13. A computer-readable medium comprising instructions which, when executed by a computer, cause the computer to carry out the steps of claim 12.

14. A data structure defining an FPGA device for use in an active interposer/chassis in a disaggregated system-on-chip comprising adapted to perform a specified function, said disaggregated system-on-chip comprising a plurality of chiplets from a predefined library of chiplets, each said chiplet implementing one or more specified operation and having a predetermined structure, said active interposer/chassis providing interoperability functions between said chiplets in view of said specified function.
